(19) United States
(12) Patent Application Publication
(10) Pub. No.: US 2016/0077498 A1
(43) Pub. Date: Mar. 17, 2016

(54) ABNORMALITY DETECTING DEVICE OF POWER TRANSMITTING MEANS, MOLDING APPARATUS, AND ABNORMALITY DETECTING METHOD OF POWER TRANSMITTING MEANS

(71) Applicant: Toshiba Kikai Kabushiki Kaisha, Tokyo (JP)

(72) Inventor: Haruyuki MATSUBAYASHI, Numazu-shi (JP)

(21) Appl. No.: 14/856,326

(22) Filed: Sep. 16, 2015

(30) Foreign Application Priority Data
Sep. 16, 2014 (JP) 2014-188176

(51) Int. Cl. G05B 1/08; B29C 45/80; H02P 31/00

(52) U.S. Cl. CPC G05B 1/08; H02P 31/00; B29C 45/80; B29C 2045/1792

(57) ABSTRACT

An abnormality detecting device of power transmitting means comprises an electric motor; a converting mechanism that converts a rotary motion of the electric motor into a linear motion; a first detector that detects rotation of the electric motor; a second detector that detects the movement of the driving object at a predetermined position; a storage device for storing, as a reference value, a rotation amount of the electric motor which is detected at normal time by the first detector and which is at a time when detecting the driving object by the second detector; and a comparing device configured to compare a rotation amount of the electric motor which is detected by the first detector when the movement of the driving object is detected by the second detector, with the reference value.

### CROSS-REFERENCE TO RELATED APPLICATIONS

This application is based upon and claims the benefit of priority from Japanese Patent Application No. 2014-188176, filed Sep. 16, 2014, the entire contents of which are incorporated herein by reference.

### BACKGROUND OF THE INVENTION

1. Field of the Invention

The present invention relates to an abnormality detecting device of power transmitting means which detects abnormality of the power transmitting means for linearly driving a driving object, a molding apparatus, and an abnormality detecting method of power transmitting means.

2. Description of the Related Art

As an injection molding machine that injection molds resin molded products, there is known a machine comprising an injecting device that injects a resin material into a mold and a mold clamping device that clamps the mold. Such an injection molding machine performs a linear operation of backward and forward moving a driving object disposed in the injecting device or the mold clamping device to perform the injection or the mold clamping. The injection molding machine converts a rotary motion from a power source such as a servo motor into a linear motion by power transmitting means, and linearly operates the driving object. Additionally, in the linear operation of the driving object, to detect a position of the driving object and move the driving object to a predetermined position, the injection molding machine comprises a detector capable of detecting the number of rotations of a drive source, or the like, and control means for controlling the position of the driving object on the basis of information detected by the detector.

The power transmitting means comprises, for example, a pair of pulleys, a timing belt, and a converting mechanism that converts the rotary motion into the linear motion. In this power transmitting means, the timing belt is used to transmit rotation of one pulley to the other pulley. Therefore, an abnormality such as tooth skipping or breaking of the timing belt might occur. When the abnormality of the timing belt occurs, information detected by a detecting device is different from the rotation of the pulley, whereby the controlled position of the driving object might shift.

Thus, in Jpn. Pat. Appln. KOKAI Publication Nos. H7-16901 and 2009-241425, as abnormality detecting means of power transmitting means, there is disclosed a technology comprising a detector capable of detecting positional information of the drive source and the driving object. This abnormality detecting means compares pieces of information which are detected in the drive source and the driving object, respectively, and the means judges abnormality, when compared values are in excess of a predetermined range.

However, in a constitution where there is used the detector that detects the positional information of not only the drive source but also the driving object, manufacturing cost increases. Thus, in the publication of Jpn. Pat. Appln. KOKAI Publication No. 2007-144777, as abnormality detecting means, there is disclosed a technology of switching on and off states of a proximity switch in accordance with the position of the driving object and detecting the abnormality on the basis of time of movement of the driving object.

In the abovementioned abnormality detecting means for detecting the abnormality on the basis of the time of the movement of the driving object, it is possible to decrease the manufacturing cost. However, the abnormality detecting means judges the abnormality on the basis of the time, and hence, for example, a slight shift of the power transmitting means cannot be detected, so that it is difficult to detect the abnormality with high accuracy.

### BRIEF SUMMARY OF THE INVENTION

According to an embodiment of the present invention, an abnormality detecting device of power transmitting means comprises an electric motor; a converting mechanism that converts a rotary motion of the electric motor into a linear motion and linearly moves, a driving object; a first detector that detects rotation of the electric motor; a second detector that detects the movement of the driving object at a predetermined position; a storage device configured to store, as a reference value, a rotation amount of the electric motor which is detected at normal time by the first detector and which is at a time when detecting the driving object by the second detector; and a comparing device configured to compare a rotation amount of the electric motor which is detected by the first detector when the movement of the driving object is detected by the second detector, with the reference value stored in the storage device.

According to an embodiment of the present invention, an abnormality detecting device of power transmitting means comprises an electric motor; a converting mechanism that converts a rotary motion of the electric motor into a linear motion and linearly moves a driving object; a first detector that detects rotation of the electric motor; a second detector that detects the movement of the driving object at a predetermined position; a storage device configured to store, as a reference value, a rotation amount of the electric motor which is detected at normal time by the first detector and which is at a time when detecting the driving object by the second detector; and a confirming device configured to confirm the detection of the second detector, when a difference between the rotation amount of the electric motor which is detected by the first detector and the reference value stored in the storage device is not in excess of a threshold value.

According to an embodiment of the present invention, a molding apparatus comprises the abnormality detecting device according to the above 1.

According to an embodiment of the present invention, an abnormality detecting method of power transmitting means is an abnormality detecting method of power transmitting means comprising an electric motor; a converting mechanism that converts a rotary motion of the electric motor into a linear motion and linearly moves a driving object; a first detector that detects rotation of the electric motor; a second detector that detects the movement of the driving object at a predetermined position; and a storing section, the method comprising storing, as a reference value in the storing section, a rotation amount of the electric motor which is detected at normal time by the first detector and which is at a time when detecting the driving object by the second detector; then detecting the movement of the driving object by the second detector; and comparing a rotation amount of the electric motor which is detected by the first detector when the movement of the driving object is detected by the second detector, with the reference value stored in the storing section.

According to an embodiment of the present invention, an abnormality detecting method of power transmitting means is an abnormality detecting method of power transmitting means comprising An abnormality detecting method of power transmitting means which detects abnormality of the power transmitting means comprising an electric motor; a converting mechanism that converts a rotary motion of the electric motor into a linear motion and linearly moves a driving object; a first detector that detects rotation of the electric motor; a second detector that detects the movement of the driving object at a predetermined position; and a storing section, the method comprises storing, as a reference value in the storing section, a rotation amount of the electric motor which is detected at normal time by the first detector and which is at a time when detecting the driving object by the second detector; then judging whether or not a difference between the rotation amount of the electric motor which is detected by the first detector and the reference value stored in the storing section is in excess of a threshold value; and confirming detection and non-detection of the driving object by the second detector, when the difference between the rotation amount of the electric motor which is detected by the first detector and the reference value stored in the storing section is not in excess of the threshold value.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory view showing a constitution of an injection molding apparatus according to one embodiment of the present invention.

### DETAILED DESCRIPTION

### First Embodiment

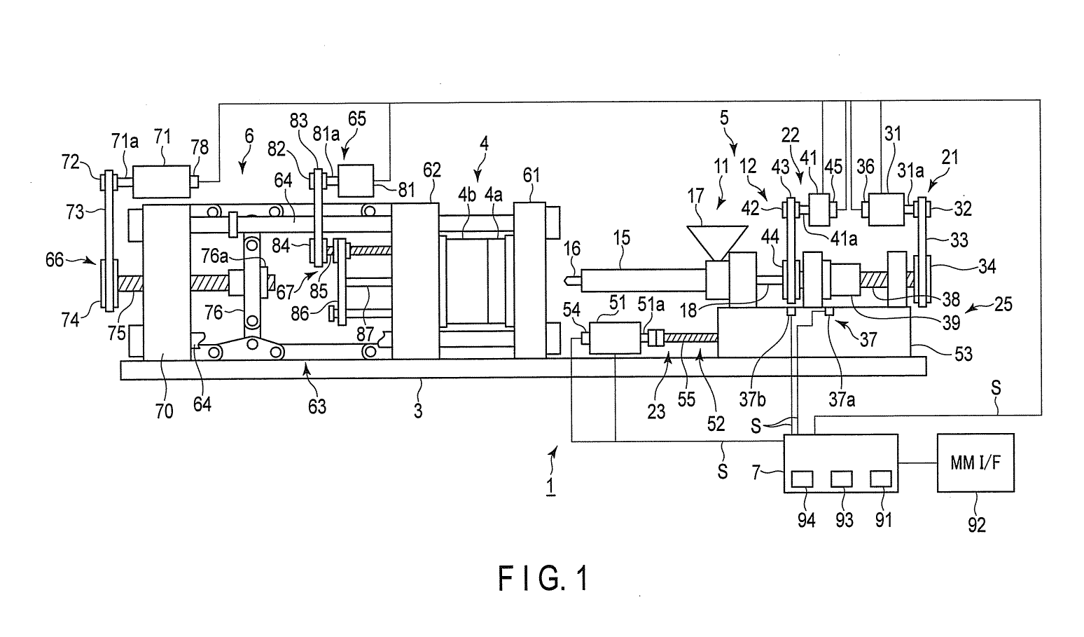

Hereinafter, an injection molding apparatus 1 according to a first embodiment of the present invention will be described with reference to FIG. 1.

FIG. 1 is an explanatory view showing a constitution of the injection molding apparatus 1 according to the first embodiment of the present invention.

As shown in FIG. 1, the injection molding apparatus 1 comprises a base portion 3, a mold 4, an injecting device 5, a mold clamping device 6, and a control device 7. The injection molding apparatus 1 is formed so that a material injected from the injecting device 5 can be formed by the mold 4. The material is, for example, a resin, glass, a metal, carbon fiber, aramid fiber, a compound of them, or a mixture of them.

The base portion 3 is configured to support the injecting device 5 and the mold clamping device 6. The mold 4 has a fixed mold 4a and a movable mold 4b.

The injecting device 5 comprises a cylinder portion 11 and driving means 12. The cylinder portion 11 comprises a cylinder 15, a nozzle 16, a hopper 17, and a screw 18.

The cylinder 15 contains the material therein. The cylinder 15 comprises a heater that heats the material contained therein. The nozzle 16 is an injecting port configured to inject the material into the mold 4.

The hopper 17 is a supply port through which the material is thrown inside. The screw 18 is disposed in the cylinder 15. An axial center of the screw 18 and an axial center of the cylinder 15 are disposed on the same axis. The screw 18 is formed to be movable along an axial center direction in the cylinder 15 and rotatable around the axial center of the screw in the cylinder 15.

The driving means 12 comprises first power transmitting means (power transmitting means or a power transmitting mechanism) 21 for linearly moving the screw (a driving object) 18 along the axial center direction of the screw (linear movement), and second power transmitting means 22 for allowing the screw 18 to perform a rotary motion. In addition, the driving means 12 comprises the cylinder portion 11, and third power transmitting means 23 for linearly moving the first power transmitting means 21 and the second power transmitting means 22.

The first power transmitting means 21 comprises a first electric motor 31, a first converting mechanism 25, a first detector 36, and a second detector 37. The first power transmitting means 21 is configured to move the screw 18 at a set speed.

The first electric motor 31 is, for example, a servo motor. The first electric motor 31 is connected to the control device 7 via a signal line S. The first electric motor 31 comprises a first rotary shaft 31a.

The first converting mechanism 25 is configured to convert a rotary motion of the first electric motor 31 into a linear motion. The first converting mechanism (a converting mechanism) 25 comprises, for example, a first driving pulley (a driving pulley) 32, a first belt 33, a first driven pulley 34, a first ball screw 38, and a first ball nut 39.

The first driving pulley 32 is fixed to the first rotary shaft 31a so that the pulley is rotatable in accordance with rotation of the first rotary shaft 31a. The first belt 33 connects the first driving pulley 32 to the first driven pulley 34. The first belt 33 is a so-called timing belt configured to transmit the rotary motion of the first driving pulley 32 to the first driven pulley 34 and rotate the first driven pulley 34.

The first driven pulley 34 is connected to the first ball screw 38, and configured to transmit, to the first ball screw 38, the rotary motion of the first driving pulley 32 which is transmitted via the first belt 33.

The first ball screw 38 is fixed to the first driven pulley 34. An axial center of the first ball screw 38 is disposed on an axial center of the first driven pulley 34.

The first ball nut 39 is disposed on the side of one end of the screw 18. The movement of the first ball nut 39 in a rotating direction is regulated. The first ball nut 39 converts the rotary motion of the first ball screw 38 into the linear motion of the first ball screw 38 in the axial center direction. The first ball nut 39 linearly moves in the axial center direction of the first ball screw 38 by the rotation of the first ball screw 38, and moves the screw 18 in the same direction.

The first detector 36 is disposed in the first electric motor 31, and configured to detect driving information of the first electric motor 31, specifically the number of rotations (a rotation amount). The first detector 36 is, for example, an encoder.

The second detector 37 is configured to detect an advanced position and a retreated position of the screw 18. Specifically, the second detector 37 comprises a first position detecting sensor 37a that can detect a retreated position of the first ball nut 39 as the retreated position of the screw 18, and a second position detecting sensor 37b that can detect an advanced position of the first ball nut 39 as the advanced position of the screw 18.

The first position detecting sensor 37a is connected to the control device 7 via the signal line S. The first position detecting sensor 37a is configured to detect, for example, the position of the first ball nut 39 when the screw 18 is positioned at the most retreated position, as the retreated position of the screw 18.

For example, the first position detecting sensor 37a is a proximity sensor or the like, and turns on when the first ball nut 39 moves to a predetermined position. The first position detecting sensor 37a is a so-called on/off switch. The first position detecting sensor 37a is configured to switch from an off-state to an on-state when detecting the position of the first ball nut 39, and to transmit the detected information to the control device 7.

The second position detecting sensor 37b is connected to the control device 7 via the signal line S. The second position detecting sensor 37b is configured to detect, for example, the position of the first ball nut 39 when the screw 18 is positioned at the most advanced position, as the advanced position of the screw 18.

For example, the second position detecting sensor 37b is a proximity sensor or the like, and turns on when the first ball nut 39 moves to the predetermined position. The second position detecting sensor 37b is a so-called on/off switch. The second position detecting sensor 37b is configured to switch from the off-state to the on-state when detecting the position of the first ball nut 39, and to transmit the detected information to the control device 7.

The second power transmitting means 22 comprises a second electric motor 41, a second driving pulley 42, a second belt 43, a second driven pulley 44, and a third detector 45.

The second electric motor 41 is, for example, a servo motor. The second electric motor 41 is connected to the control device 7 via the signal line S. The second electric motor 41 comprises a second rotary shaft 41a.

The second driving pulley 42 is fixed to the second rotary shaft 41a to be rotatable in accordance with the rotation of the second rotary shaft 41a. The second belt 43 connects the second driving pulley 42 to the second driven pulley 44. The second belt 43 is configured to transmit the rotary motion of the second driving pulley 42 to the second driven pulley 44 and rotate the second driven pulley 44. The second belt 43 is a so-called timing belt.

The second driven pulley 44 is connected to the screw 18. The second driven pulley 44 is configured to transmit, to the screw 18, the rotary motion of the second driving pulley 42 transmitted via the second belt 43.

The third detector 45 is disposed in the second electric motor 41, and configured to detect the driving information of the second electric motor 41, specifically the number of rotations. The third detector 45 is, for example, an encoder.

The third power transmitting means 23 comprises a third electric motor 51, a second converting mechanism 52, a movable base 53, and a fourth detector 54.

The third electric motor 51 is, for example, a servo motor, and connected to the control device 7 via the signal line S. The third electric motor 51 comprises a third rotary shaft 51a. The second converting mechanism 52 is configured to convert the rotary motion of the third rotary shaft 51a into the linear motion. The second converting mechanism 52 comprises, for example, a second ball screw 55 and a second ball nut. The second ball screw 55 is fixed to the third rotary shaft 51a. An axial center of the second ball screw 55 is disposed on the same axial center as in the third rotary shaft 51a and the second ball screw 55.

The second ball nut is disposed in the movable base 53, and configured to convert the rotary motion of the ball screw 55 into the linear motion of the second ball screw 55 in the axial center direction. The second ball nut linearly moves in the axial center direction of the second ball screw 55 in accordance with the rotation of the second ball screw 55, and moves the movable base 53 in the same direction.

The movable base 53 is movably supported by the base portion 3. The movable base 53 supports the cylinder portion 11, the first power transmitting means 21 and the second power transmitting means 22 in an upper portion of the movable base. The fourth detector 54 is disposed in the third electric motor 51, and configured to detect the driving information of the third electric motor 51, specifically the number of the rotations. The fourth detector 54 is, for example, an encoder.

The mold clamping device 6 is configured to hold the fixed mold 4a and the movable mold 4b and open and close the mold 4. The mold clamping device 6 comprises, for example, a fixing plate (a fixing member) 61, a movable plate (a movable member) 62, an opening/closing mechanism 63, a tie bar 64, and an extruding mechanism 65.

The fixing plate 61 is a so-called fixing die plate, and is fixed to the base portion 3. The fixing plate 61 is configured to fix the fixed mold 4a.

The movable plate 62 is a so-called movable die plate, and disposed to face the fixing plate 61. The movable plate 62 is formed to be movable in a direction in which the movable plate approaches to and separates from the fixing plate 61. Specifically, the movable plate 62 is formed to be linearly movable in an advancing direction and a retreating direction to and from the fixing plate 61 (the linear movement) via the tie bar 64 by the opening/closing mechanism 63 or an unshown mold thickness regulating mechanism. The movable plate 62 is configure to fix the movable mold 4b of the mold 4.

The opening/closing mechanism 63 is configured to move the movable plate 62 by a toggle mechanism, thereby opening and closing the mold 4. In other words, the opening/closing mechanism 63 is formed so that the movable mold 4b fixed to the movable plate 62 is separable from and approachable to the fixed mold 4a. The opening/closing mechanism 63 comprises a link housing (a pressure receiving plate) 70, a fourth electric motor 71, a third driving pulley 72, a third belt 73, a third driven pulley 74, a fourth ball screw 75, a crosshead 76, a toggle link 77, and a fifth detector 78.

The link housing 70 becomes a supporting point of the crosshead 76 and the toggle link 77. The link housing 70 is supported by the base portion 3.

The fourth electric motor 71 is, for example, a servo motor, and connected to the control device 7 via the signal line S. The fourth electric motor 71 comprises a fourth rotary shaft 71a.

The third driving pulley 72 is fixed to the fourth rotary shaft 71a to be rotatable in accordance with the rotation of the fourth rotary shaft 71a. The third belt 73 connects the third driving pulley 72 to the third driven pulley 74. The third belt 73 is a so-called timing belt configured to transmit the rotary motion of the third driving pulley 72 to the third driven pulley 74 and rotate the third driven pulley 74.

The third driven pulley 74 is connected to the fourth ball screw 75, and configured to transmit, to the fourth ball screw 75, the rotary motion of the third driving pulley 72 which is transmitted via the third belt 73.

The crosshead 76 is connected to the fourth ball screw 75, and formed to be movable along the axial center direction of the fourth ball screw 75 by the rotation of the fourth ball screw 75. Specifically, the crosshead 76 comprises a third ball nut 76a. In addition, the crosshead 76 is formed to be movable in the axial center direction of the third ball screw 75, whereby the toggle link 77 is operable.

It is to be noted that a mechanism comprising the third driving pulley (the driving pulley) 72 capable of converting the rotary motion of the fourth electric motor 71 into the linear motion, the third belt 73, the third driven pulley 74, the fourth ball screw 75 and the crosshead 76 is called a third converting mechanism (the converting mechanism) 66 sometimes.

The toggle link 77 is connected to the movable plate 62, the link housing 70 and the crosshead 76. The toggle link 77 is constituted of links, bushes and pins constituting the toggle mechanism. The toggle link 77 is formed to be operated by the crosshead 76 so that the movable plate 62 is movable to the fixing plate 61. The fifth detector 78 is disposed in the fourth electric motor 71, and configured to detect the driving information of the fourth electric motor 71, specifically the number of the rotations. The fifth detector 78 is, for example, an encoder.

The opening/closing mechanism 63 transmits the rotary motion of the fourth rotary shaft 71a to the fourth ball screw 75 via the third driving pulley 72, the third belt 73 and the third driven pulley 74, and converts the rotary motion of the fourth ball screw 75 into the linear motion of the crosshead 76.

In addition, the opening/closing mechanism 63 transmits the linear motion of the crosshead 76 to the movable plate 62 via the toggle link 77. In consequence, the opening/closing mechanism 63 allows the movable plate 62 to linearly move to the fixing plate 61.

The tie bars 64 are fixed to, for example, the fixing plate 61 and the link housing 70. The tie bars 64 couple the fixing plate 61 with the link housing 70. The tie bars 64 are configured to guide the movement of the movable plate 62. For example, four tie bars 64 are arranged at four corners of each of the fixing plate 61 and the link housing 70.

The extruding mechanism 65 comprises, for example, a fifth electric motor 81 connected to the control device 7 via the signal line S and having a fifth rotary shaft 81a, a fourth driving pulley 82, a fourth belt 83, a fourth driven pulley 84, a fifth ball screw 85, an extruding plate 86 having a fifth ball nut 86a, an extruding pin 87 fixed to the extruding plate 86, and a sixth detector 88.

The extruding mechanism 65 is configured to transmit the rotary motion of the fifth rotary shaft 81a of the fifth electric motor 81 to the fifth ball screw 85 via the fourth driving pulley 82, the fourth belt 83 and the fourth driven pulley 84. The extruding plate 86 is formed to be linearly movable in accordance with the rotation of the fifth ball screw 85 by the fifth ball nut 86a. The extruding plate 86 is formed so that the extruding pin 87 is movable by the movement of the extruding plate.

It is to be noted that a mechanism comprising the fourth driving pulley (the driving pulley) 82 capable of converting the rotary motion of the fifth electric motor 81 into the linear motion, the fourth belt 83, the fourth driven pulley 84, the fifth ball screw 85 and the extruding plate 86 will be called a fourth converting mechanism (the converting mechanism) 67 sometimes.

The extruding mechanism 65 is connected to the movable plate 62, and moves the extruding plate 86 to project the extruding pin 87 from the movable mold 4b, thereby extruding a molded product. The sixth detector 88 is disposed in the fifth electric motor 81, and configured to detect the driving information of the fifth electric motor 81, specifically the number of the rotations. The sixth detector 88 is, for example, an encoder.

The control device 7 is electrically connected to the first electric motor 31, the second electric motor 41, the third electric motor 51, the fourth electric motor 71, the fifth electric motor 81, the first detector 36, the first position detecting sensor 37a, the second position detecting sensor 37b, the third detector 45, the fourth detector 54, the fifth detector 78 and the sixth detector 88 via the signal line S.

The control device 7 comprises, for example, a storing section 91 and a comparing section (a comparing device) 93. The control device 7 is connected to a man machine interface (MMI/F) 92 electrically connected to a device that inputs an instruction from the outside.

For the storing section 91, for example, the first detector 36 detects the position of the first ball nut 39 which is detected by the first position detecting sensor 37a of the second detector 37, when the first power transmitting means 21 normally operates, and the position is stored as a reference value in the storing section, directly or via calculation in the control device 7.

It is to be noted that, in this case, the reference value is information indicating the position of the screw 18 at the position of the first position detecting sensor 37a. Specifically, the reference value is a rotation amount of the first electric motor 31 when the first position detecting sensor 37a is detected.

In addition, the control device 7 has the following function (1) to function (3).

(1) A function of detecting the rotation amount of the first electric motor 31, when the position of the driving object is detected by the first position detecting sensor 37a.

(2) A function of comparing a difference between the rotation amount of the first electric motor 31 and the rotation amount (the reference value) stored in the storing section 91, with a predetermined threshold value.

(3) A function of judging a state of the first power transmitting means 21 from the result of the function (2).

Next, the function (1) to the function (3) which the control device 7 has will be described.

The function (1) is a function of detecting the first ball nut 39 by the first position detecting sensor 37a to detect that the first ball nut 39 as the driving object moves to the most retreated position, and detecting the rotation amount of the first electric motor 31 at the most retreated position.

The function (2) is a function of comparing a difference between the rotation amount of the first electric motor 31 at the position of the first position detecting sensor 37a of the first ball nut 39 detected by the function (1) and the rotation amount of the first electric motor 31 in the first position detecting sensor 37a of the first ball nut 39 at normal time which is stored by the storing section 91, with a predetermined threshold value determined in advance. The function (2) is comparing means for comparing a difference between the present rotation amount of the first electric motor 31 and the rotation amount of the first electric motor 31 in the first position detecting sensor 37a of the first ball nut 39 at the normal time, with the predetermined threshold value determined in advance. That is, the control device 7 compares a difference between the present rotation amount of the first electric motor 31 at the most retreated position of the first ball nut 39 and the rotation amount of the first electric motor 31 in the first position detecting sensor 37a of the first ball nut 39 at the normal time, with the predetermined threshold value determined in advance. The function (2) is provided in, for example, the comparing section (a comparing device) 93.

The function (3) is a function of judging, from the result of the function (2), whether or not the first power transmitting means 21 has normally operated. The function (3) is judging means for judging a state of the first power transmitting means 21, i.e., normality and abnormality of the movement of the first ball nut 39 that is the driving object.

The function (3) is a function of judging that the first power transmitting means 21 is normal, when the difference between the present rotation amount of the first electric motor 31 at the most retreated position of the first ball nut 39 and the rotation amount of the first electric motor 31 in the first position detecting sensor 37a of the first ball nut 39 at the normal time is the predetermined threshold value determined in advance or less. In addition, the function (3) is a function of judging that the first power transmitting means 21 is abnormal, when the difference between the present rotation amount of the first electric motor 31 at the most retreated position of the first ball nut 39 and the rotation amount of the first electric motor 31 in the first position detecting sensor 37a of the first ball nut 39 at the normal time is larger than the predetermined threshold value.

In addition, as the function (3), the control device 7 stops the first electric motor 31, when it is judged that the first power transmitting means 21 is abnormal.

The control device 7 constitutes an abnormality detecting device that detects the abnormality of the movement of the first ball nut 39 that is the driving object or the abnormality of the first power transmitting means 21.

In the injection molding apparatus 1 having such a constitution, the control device 7 drives the first electric motor 31 to move the first ball nut 39, and moves the screw 18 in accordance with a moving instruction for the screw 18 of the injecting device 5 during a molding operation or a moving instruction (more specifically, a retreating instruction) of the screw 18 of the injecting device 5 by an operator's operation of an operating switch.

Next, when the first ball nut 39 moves to the most retreated position, the first position detecting sensor 37a responds, and the control device 7 detects the rotation amount of the first electric motor 31 of the first ball nut 39, when the first position detecting sensor 37a responds.

Next, the control device 7 detects a difference between the detected rotation amount of the first electric motor 31 at the most retreated position of the first ball nut 39 and the rotation amount of the first electric motor 31 at the most retreated position of the first ball nut 39 at the normal time which is stored in the storing section 91.

Next, when the control device compares the calculated value with the predetermined threshold value determined in advance and the calculated value is the predetermined threshold value or less, the control device judges that the first ball nut 39 normally moves, and when the molding operation is being performed, the control device continues the molding operation. When the calculated value is in excess of the predetermined threshold value, it is judged that the movement of the first ball nut 39 is abnormal, i.e., the abnormality occurs in the first power transmitting means 21, and it is reported that the first power transmitting means 21 is abnormal. In addition, the driving of the injecting device 5 is stopped. It is to be noted that the control device 7 or the injection molding apparatus 1 has reporting means such as a lamp that generates red light or a buzzer and display means such as a display, as means for reporting the abnormality.

According to the injection molding apparatus 1 having such a constitution, the present rotation amount of the first electric motor 31 is compared with the rotation amount (the reference value) of the first electric motor 31 at the normal time which is stored in the storing section 91, and hence, it is possible to detect not only the abnormality of the first power transmitting means 21 but also the abnormality of the movement of the screw 18.

Specifically, the first power transmitting means 21 connects the first driving pulley 32 to the first driven pulley 34 by the first belt 33. Therefore, a transmission loss of a power might occur in the first driving pulley 32 or the first driven pulley 34 and the first belt 33 due to a slip or the like, and the first belt 33 might break during the driving. In such a case, the first electric motor 31 has a larger rotation amount than that at the normal time. In consequence, as judging means, the control device 7 can accurately judge not only normality and abnormality of the first power transmitting means 21 but also normality and abnormality of the movement of the screw 18 from the comparison result between the present rotation amount of the first electric motor 31 and the rotation amount of the first electric motor 31 at the normal time.

In the injection molding apparatus 1, even when the position of the first ball nut 39 as the driving object shifts after maintenance of the injection molding apparatus 1 or the like, it is possible to find this shift by comparison with the positional information (the reference value) of the first ball nut 39 at the normal time which is stored in the storing section 91.

In the injection molding apparatus 1, the control device 7 detects the abnormality of the first power transmitting means 21 and then stops the first electric motor 31, and hence, damages of the injection molding apparatus 1 can be prevented.

In addition, there is not any special restriction on the second detector 37 as long as the position of the driving object can be detected, and a comparatively inexpensive detector such as a proximity sensor that only outputs the on and off states is usable in the first position detecting sensor 37a. In consequence, it is possible to accurately detect the abnormality without enlarging manufacturing cost of the injection molding apparatus 1.

As described above, according to the injection molding apparatus 1 of the first embodiment of the present invention, it is possible to detect the abnormality of the movement of the driving object inexpensively and with high detection accuracy by the first power transmitting means 21 and the control device 7.

### Second Embodiment

Next, an injection molding apparatus 1 according to a second embodiment of the present invention will hereinafter be described.

It is to be noted that a constitution of the injection molding apparatus 1 according to the second embodiment is equal to that of the injection molding apparatus 1 according to the abovementioned first embodiment, and is different in functions of the control device 7. Therefore, the injection molding apparatus 1 according to the second embodiment is denoted with the same reference signs as in the injection molding apparatus 1 according to the first embodiment, and detailed description of the constitution is omitted.

The control device 7 for use in the injection molding apparatus 1 according to the second embodiment is electrically connected to a first electric motor 31, a second electric motor 41, a third electric motor 51, a fourth electric motor 71, a fifth electric motor 81, a first detector 36, a first position detecting sensor 37a and a second position detecting sensor 37b via a signal line S in the same manner as in the control device 7 according to the abovementioned first embodiment.

The control device 7 has, for example, a storing section (a storage device) 91 for storing, as a reference value, a rotation amount of the first electric motor 31 when first power transmitting means 21 normally operates, a comparing section (a comparing device) 93, and a confirming section (a confirming device) 94.

The control device 7 has the following functions (4) to (6).

(4) A function of comparing a difference between the rotation amount of the first electric motor 31 and the reference value stored in the storing section 91, with a threshold value.

(5) A function of detecting a state of the first position detecting sensor 37a.

(6) A function of judging a state of the first power transmitting means 21 from the state of the first position detecting sensor 37a.

Next, the function (4) to the function (6) which the control device 7 has will be described.

The function (4) is a function comparing a difference between the rotation amount of the first electric motor 31 and the rotation value (the reference value) of the first electric motor 31 at normal time which is stored in the storing section 91, with a predetermined allowable value (threshold value) determined in advance. The function (4) judges whether or not the difference between the rotation amount of the first electric motor 31 and the rotation amount (the reference value) of the first electric motor 31 at the normal time which is stored in the storing section 91 is in excess of the predetermined allowable value (threshold value) determined in advance. This function (4) is provided in, for example, the comparing section 93.

The function (5) is confirming means. The function (5) is a function of detecting the state of the first position detecting sensor 37a when the difference between the rotation amount of the first electric motor 31 and the rotation amount (the reference value) of the first electric motor 31 at the normal time which is stored in the storing section 91 is not in excess of the predetermined allowable value (threshold value) determined in advance as a result of the function (4), thereby confirming whether or not a first ball nut 39 itself is most retreated or positioned in the vicinity of the most retreated position. That is, the function (5) is a function of detecting that the first ball nut 39 itself is positioned at the most retreated position or in the vicinity of the most retreated position when the first position detecting sensor 37a is turned on. In addition, the function (5) is a function of detecting that the first ball nut 39 itself does not reach the vicinity of the most retreated position when the first position detecting sensor 37a is turned off. The function (5) is provided in, for example, the confirming section 94.

The function (6) is a function of judging the state of the first power transmitting means 21 from the state of the first position detecting sensor 37a which is confirmed by the function (5). Specifically, the function (6) judges that the first power transmitting means 21 is normal, when the difference between the present rotation amount of the first electric motor 31 and the rotation amount (the reference value) of the first electric motor 31 at the normal time which is stored in the storing section 91 is not in excess of the predetermined allowable value (threshold value) determined in advance and the first ball nut 39 itself is positioned at the most retreated position or in the vicinity of the most retreated position.

In addition, the function (6) judges that the first power transmitting means 21 is abnormal, when the difference between the present rotation amount of the first electric motor 31 and the rotation amount (the reference value) of the first electric motor 31 at the normal time which is stored in the storing section 91 satisfies the predetermined allowable value (threshold value) determined in advance and the first ball nut 39 itself is not positioned in the vicinity of the most retreated position. Furthermore, the function (6) has a function of stopping the first electric motor 31 when judging that the first power transmitting means 21 is abnormal. The function (6) may be provided in, for example, the confirming section 94.

In the injection molding apparatus 1 having such a constitution, the control device 7 detects the rotation of the first electric motor 31 by the first detector 36, and judges whether or not the rotation amount of the electric motor 31 which is detected by the first detector 36 reaches a value in an allowable range (a range of the threshold value) in the rotation amount of the first electric motor 31 at the normal time which is stored in the storing section 91.

When the rotation amount of the first electric motor 31 which is detected by the first detector 36 reaches the value in the allowable range (the range of the threshold value) in the rotation amount of the first electric motor 31 at the normal time which is stored in the storing section 91, the control device 7 confirms detection and non-detection of the first ball nut 39 by the first position detecting sensor 37a of a second detector 37. Further, the control device 7 judges that the first power transmitting means 21 is normal, when the first ball nut 39 is detected by the first position detecting sensor 37a, i.e., when the first position detecting sensor 37a is turned on.

In addition, the control device 7 judges that the first power transmitting means 21 is abnormal, when the first ball nut 39 is not detected by the first position detecting sensor 37a, i.e., when the first position detecting sensor 37a is turned off, and the control device stops the first electric motor 31.

According to the injection molding apparatus 1 having such a constitution, it is possible to accurately detect not only normality and abnormality of the first power transmitting means 21 but also normality and abnormality of movement of the screw 18 in the same manner as in the first embodiment.

Additionally, in the injection molding apparatus 1, the control device 7 detects the abnormality of the first power transmitting means 21 and then stops the first electric motor 31, and hence, damages of the injection molding apparatus 1 can be prevented.

In addition, there is not any special restriction on the second detector 37 as long as a position of a driving object can be detected, and a comparatively inexpensive detector such as a proximity sensor that only outputs on and off states is usable in the first position detecting sensor 37a. In consequence, it is possible to accurately detect the abnormality without enlarging manufacturing cost of the injection molding apparatus 1.

As described above, according to the injection molding apparatus 1 of the second embodiment of the present invention, it is possible to detect the abnormality of the movement of the driving object inexpensively and with high detection accuracy by the first power transmitting means 21 and the control device 7 in the same manner as in the injection molding apparatus 1 according to the abovementioned first embodiment.

It is to be noted that the present invention is not limited to the above embodiments. For example, in the abovementioned example, the driving object is the screw 18, and there has been described the constitution to detect the position of the first ball nut 39 by the second detector 37 for the purpose of detecting the movement of the screw 18. For example, the abnormality detecting device of the power transmitting means may have a constitution where the opening/closing mechanism 63 is defined as the power transmitting means (the power transmitting mechanism), the driving object is the movable plate 62, and for the purpose of detecting a position of the movable plate 62, a position of the crosshead 76 is detected by the control device 7 and the second detector 37.

In addition, for example, the abnormality detecting device of the power transmitting means may have a constitution where the extruding mechanism 65 is defined as the power transmitting means (the power transmitting mechanism), the driving object is the extruding plate 86 or the extruding pin 87, and for the purpose of detecting a position of the extruding plate 86 or the extruding pin 87, a position of the fifth ball nut 86a is detected by the control device 7 and the second detector 37. In addition, the abnormality detecting device of the power transmitting means may have a constitution where the third power transmitting means 23 is defined as the power transmitting means (the power transmitting mechanism), the driving object is the movable base 53, and a position of the movable base 53 is detected by the control device 7 and the second detector 37.

That is, a position where the second detector 37 is disposed may be changed in accordance with the position of the driving object. In addition, when the driving objects are present, the second detectors 37 may be disposed in the driving objects, respectively.

Additionally, in the abovementioned embodiments, the first position detecting sensor 37a of the second detector 37 is used, but the present invention is not limited to these embodiments. For example, even when the first position detecting sensor 37a of the second detector 37 is replaced with the second position detecting sensor 37b of the second detector 37 in the abovementioned embodiments, effects of the present invention can be obtained. That is, the position of the second detector 37 may be any position in a driving range of the driving object.

Additionally, in the abovementioned examples, there has been described the constitution where the abnormality detecting device of the power transmitting means is used in the injection molding apparatus 1, but the present invention is not limited to this constitution, and there may be used a device such as a die cast machine having the power transmitting means for converting the rotary motion into the linear motion and linearly moving the driving object. Additionally, the present invention can variously be embodied without departing from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An abnormality detecting device of power transmitting means, comprising:
an electric motor;
a converting mechanism that converts a rotary motion of the electric motor into a linear motion and linearly moves a driving object;
a first detector that detects rotation of the electric motor;
a second detector that detects the movement of the driving object at a predetermined position;
a storage device configured to store, as a reference value, a rotation amount of the electric motor which is detected at normal time by the first detector and which is at a time when detecting the driving object by the second detector; and
a comparing device configured to compare a rotation amount of the electric motor which is detected by the first detector when the movement of the driving object is detected by the second detector, with the reference value stored in the storage device.

2. An abnormality detecting device of power transmitting means, comprising:
an electric motor;
a converting mechanism that converts a rotary motion of the electric motor into a linear motion and linearly moves a driving object;
a first detector that detects rotation of the electric motor;
a second detector that detects the movement of the driving object at a predetermined position;
a storage device configured to store, as a reference value, a rotation amount of the electric motor which is detected at normal time by the first detector and which is at a time when detecting the driving object by the second detector; and
a confirming device configured to confirm the detection of the second detector, when a difference between the rotation amount of the electric motor which is detected by the first detector and the reference value stored in the storage device is not in excess of a threshold value.

3. A molding apparatus which comprises the abnormality detecting device according to claim 1.

4. A molding apparatus which comprises the abnormality detecting device according to claim 2.

5. An abnormality detecting method of power transmitting means which detects abnormality of the power transmitting means comprising:
an electric motor;
a converting mechanism that converts a rotary motion of the electric motor into a linear motion and linearly moves a driving object;
a first detector that detects rotation of the electric motor;
a second detector that detects the movement of the driving object at a predetermined position; and
a storing section, the method comprising:
storing, as a reference value in the storing section, a rotation amount of the electric motor which is detected at normal time by the first detector and which is at a time when detecting the driving object by the second detector;
detecting the movement of the driving object by the second detector; and
comparing a rotation amount of the electric motor which is detected by the first detector when the movement of the driving object is detected by the second detector, with the reference value stored in the storing section.

6. An abnormality detecting method of power transmitting means which detects abnormality of the power transmitting means comprising:
an electric motor;
a converting mechanism that converts a rotary motion of the electric motor into a linear motion and linearly moves a driving object;
a first detector that detects rotation of the electric motor;
a second detector that detects the movement of the driving object at a predetermined position; and
a storing section, the method comprising:
storing, as a reference value in the storing section, a rotation amount of the electric motor which is detected at normal time by the first detector and which is at a time when detecting the driving object by the second detector;
judging whether or not a difference between the rotation amount of the electric motor which is detected by the first detector and the reference value stored in the storing section is in excess of a threshold value; and
confirming detection and non-detection of the driving object by the second detector, when the difference between the rotation amount of the electric motor which is detected by the first detector and the reference value stored in the storing section is not in excess of the threshold value.
